(19) United States
(12) Patent Application Publication
(10) Pub. No.: US 2009/0124494 A1
(43) Pub. Date: May 14, 2009

(54) Catalyst For Purifying Exhaust Gases and Exhaust-Gas Purification Controller Using the Same

(76) Inventors: Hiromasa Suzuki, Aichi-ken (JP); Takahiko Fujiwara, Shizuoka-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/883,444

(22) PCT Filed: Jan. 19, 2006
(86) PCT No.: PCT/JP06/01177

§ 371 Date: Jul. 31, 2007

(30) Foreign Application Priority Data
Jan. 31, 2005 (JP) 2005-024285

(51) Int. Cl. B01J 23/40

(52) U.S. Cl. 502/325; 502/304

(57) ABSTRACT

A catalyst for purifying exhaust gases includes a support substrate, and a catalytic loading layer. The support substrate has an exhaust-gas flow passage. The catalytic loading layer is formed on a surface of the exhaust-gas flow passage, and is composed of a porous oxide support and a catalytic ingredient. The catalytic loading layer includes an Rh area, and an oxidizing area. On the Rh area, rhodium is loaded as the catalytic ingredient. The oxidizing area is formed on an exhaust-gas flow downstream side with respect to the Rh area. On the oxidizing area, a catalytic ingredient exhibiting an oxidizing activity at least is loaded. Also disclosed is an exhaust-gas purification controller using the same.

### TECHNICAL FIELD

The present invention relates to a catalyst for purifying exhaust gases, such as a three-way catalyst for purifying HC, CO and NOₓ in exhaust gases, and an exhaust-gas purification controller using the same. In particular, it relates to a catalyst for purifying exhaust gases, catalyst which is good in terms of the HC purifying performance in low-temperature regions, such as at the time of starting engine, and an exhaust-gas purification controller using the same, exhaust-gas purification controller which can control the combustion of internal combustion engine optimally and can accordingly demonstrate high NOₓ purifying performance.

### BACKGROUND ART

As a catalyst for purifying automotive exhaust gases, a three-way catalyst has been used extensively conventionally. The three-way catalyst comprises a porous support, such as alumina, and a noble metal, such as Pt, loaded on the porous support, and can purify CO, HC and NOₓ efficiently at around the theoretical air-fuel ratio.

Among the noble metals, Pt and Pd contribute to the oxidation purification of CO and HC mainly, and Rh contributes to the reduction purification of NOₓ mainly, and at the same Rh acts to inhibit the sintering of Pt or Pd. Therefore, it has been understood that, by using Pt or Pd with Rh combinedly, it is possible to suppress the drawback that the activity of Pt or Pd has been lowered by the decrease of active sites in Pt or Pd resulting from the sintering of Pt or Pd, and that it is accordingly possible to improve the heat resistance of Pt or Pd.

The noble metal loaded on the three-way catalyst does not effect the catalytic reaction at temperatures lower than the activation temperature. Accordingly, there has been a drawback that the emission of HC is abundant, because the three-way catalyst does not function sufficiently in exhaust gases whose temperature falls in low-temperature region, such as at the time of starting engine. Moreover, the following fact is another cause of the drawback. That is, the air-fuel ratio has often become fuel-rich atmospheres so that the HC content is abundant when an engine is cold started.

Hence, as disclosed in Japanese Unexamined Patent Publication (KOKAI) No. 6-205,983, it has been often carried out to increase the loading amount of noble metal on the exhaust-gas flow upstream side of catalyst. On the exhaust-gas flow upstream side of catalyst, since exhaust gases, which have not been turned into the laminar flow, collide with the cellular walls of catalyst, the temperature increment of catalyst is so quick that the noble metal reaches the activation temperature quickly relatively. After the noble metal reaches the activation temperature, the temperature of catalyst is increased furthermore by the reaction heat of the noble metal. Accordingly, the temperature increment of catalyst is facilitated on the exhaust-gas flow downstream side. Consequently, the purifying performance of catalyst is improved in low-temperature region.

However, when increasing the loading amount of Pt, for instance, the loading density of Pt heightens. Accordingly, the sintering between Pt particles has facilitated. Consequently, there has been a drawback that that the activity of Pt is likely to lower.

Moreover, it has been known to use Pd whose HC oxidizing activity is high especially as the noble metal. For example, Japanese Unexamined Patent Publication (KOKAI) No. 8-24,644 proposes a catalyst in which Pd is loaded over the entire length of the catalyst and at the same time Pt is loaded on the exhaust-gas flow upstream side of the catalyst. This catalyst demonstrates high purifying performance, because the balance between the characteristics of Pd, whose three-way activity is good at around the stoichiometric point, and the characteristics of Pt, whose NOₓ purifying performance is good on fuel-lean sides, is optimized.

In addition, Japanese Unexamined Patent Publication (KOKAI) No. 8-332,350 proposes a catalyst in which Pd and Rh are loaded on the exhaust-gas flow upstream side and Pt and Rh are loaded on the downstream side with respect to Pd and Rh. This catalyst is good in terms of the HC purifying performance in low-temperature region and the durability at high temperatures, because Pd is loaded in a higher concentration on the upstream side. Moreover, this catalyst demonstrates high NOₓ purifying performance, because the upstream-side reaction enhances the activity of the downstream-side Pt.

However, there is a problem that the NOₓ purifying performance of catalyst is lower when Pd and Rh coexist than when Pt and Rh coexist. Moreover, the alloying of Pd with Rh is more likely to develop than the alloying of Pt with Rh. Accordingly, there is a drawback that the alloying has lowered the characteristics of Rh. In addition, since Rh is extremely scarce as resource, it has been desired to make use of Rh efficiently and at the same time to enhance the durability of Rh by suppressing the degradation.

Note that the three-way catalyst oxidizes HC and CO and reduces NOₓ to purify them in exhaust-gas atmospheres at around the stoichiometric point. Accordingly, it is essential to control the air-fuel ratio of engine so that the exhaust-gas atmospheres are at around the stoichiometric point. It is possible to carry out such a control by detecting a physical quantity, such as the oxygen concentration in exhaust gases emitted from engine, which relates to the catalyst-inlet gas atmosphere, and carrying out the feed back control of the air-fuel ratio (A/F) of engine depending on the physical quantity. However, even when air-fuel mixtures with fuel-rich air-fuel ratios are combusted to produce exhaust gases, the catalyst-outlet gas atmospheres might be turned into the stoichiometric atmosphere or fuel-lean atmospheres, because HC have been consumed in the three-way catalyst. Consequently, the exhaust-gas atmospheres immediately downstream to engine might differ from the exhaust-gas atmospheres at the outlet of the three-way catalyst.

Hence, a first sensor for detecting a physical quantity, which relates to the three-way catalyst-inlet gas atmospheres, and a second sensor for detecting a physical quantity, which relates to the three-way catalyst-outlet gas atmospheres, have been disposed in an exhaust system of engine conventionally. The output difference between the first and second sensors has been judged to change the fuel injection volume. Thus, it is possible to control the air-fuel ratio optimally depending on the degree of three-way catalyst's activity, and accordingly it is possible to secure high conversions. Moreover, when there should be a difference between both atmospheres, which the first and second sensor detect, and when the difference is detected so that it is lower than a predetermined range, it is possible to know the replacement timing of three-way catalyst explicitly.

One of the inventors of the present invention proposed a novel catalyst in Japanese Patent Application No. 2004-262,301. The catalyst has a catalytic loading layer, which comprises: a coexistence area on which Rh and Pt are loaded over an area extending from the exhaust-gas inlet-end surface of a support substrate to a location of 4/10 or less of the overall length of the support substrate; and an Rh area which is formed from the coexistence area to the exhaust-gas flow downstream side, and on which Rh is loaded uniformly in the exhaust-gas flow direction. In this catalyst, since the coexistence area with Pt and Rh loaded is formed on the exhaust-gas flow upstream side, which is more likely to become high temperatures than the exhaust-gas flow downstream side, Rh suppresses the sintering of Pt in the coexistence area. Accordingly, the activity of Pt is inhibited from lowering. Moreover, even if Pt is alloyed with Rh in the coexistence area to degrade the characteristics of Rh, Rh, which is loaded on the Rh area, shows the characteristics fully, and additionally the length of the coexistence area is 4/10 or less of the overall length of the support substrate. Consequently, it is possible to make use of Rh efficiently.

However, when trying to control the air-fuel ratio of engine depending on the output values from the first and second sensors as described above, using the novel catalyst proposed in Japanese Patent Application No. 2004-262,301 as a three-way catalyst, there has been a problem that large errors arise in the output values from the second sensor. That is, immediately after combusting an air-fuel fuel mixture with a fuel-rich A/F ratio in engine, the outlet gas from the three-way catalyst should be a fuel-lean atmosphere because HC have been consumed to reduce NOₓ. However, there occurs a drawback that the output value from the second sensor has indicated that the outlet gas from the three-way catalyst is a fuel-rich atmosphere. If such is the case, since an engine control unit controls the air-fuel ratio to turn it into the stoichiometric air-fuel ratio, not only the NOₓ conversion of the three-way catalyst has degraded, but also the accuracy of air-fuel ratio control has deteriorated. Eventually, the accuracy of grasping the deterioration degree of three-way catalyst has lowered.

One of the causes that bring out such a problem is believed to be as follows. When the inlet gas to the above-described novel catalyst is in a fuel-rich atmosphere, the Rh area of the novel catalyst facilitates the steam reforming reaction to generate H₂. The resulting H₂ has fluctuated the sudden output change-over point (or threshold value) of the second sensor.

### DISCLOSURE OF THE INVENTION

The present invention has been developed in view of the aforementioned circumstances. It is therefore an object of the present invention to control the air-fuel ratio of internal combustion engine optimally by inhibiting the unnecessary fluctuation of the sudden output change-over point of the second sensor, unnecessary fluctuation which results from H₂ generated in the Rh area of the novel catalyst.

A catalyst according to the present invention for purifying exhaust gases achieves the aforementioned object, and comprises:

a support substrate having an exhaust-gas flow passage; and

a catalytic loading layer formed on a surface of the exhaust-gas flow passage, and composed of a porous oxide support and a catalytic ingredient, the catalytic loading layer comprising:

an Rh area on which rhodium is loaded as the catalytic ingredient; and

an oxidizing area which is formed on an exhaust-gas flow downstream side with respect to the Rh area, and on which a catalytic ingredient exhibiting an oxidizing activity at least is loaded.

In the present catalyst, the catalytic loading layer can desirably further comprise a coexistence area, which is formed on an exhaust-gas flow upstream side with respect to the Rh area, and on which rhodium and platinum are loaded as the catalytic ingredient. Moreover, it is preferable that the support substrate can have a predetermined overall length; the coexistence area of the catalytic loading layer can have a length which is 4/10 times or less as short as the predetermined overall length of the support substrate; and the coexistence area can comprise rhodium and platinum in a proportion of Pt with respect to Rh falling in a range of 10≦Pt/Rh≦60 by weight ratio. In addition, the porous support can preferably include ceria at least.

An exhaust-gas purification controller according to the present invention achieves the aforementioned object, and comprises:

the present catalyst, and disposed in an exhaust channel of an internal combustion engine;

a first sensor disposed on an exhaust-gas flow upstream side with respect to the present catalyst, and detecting a physical quantity relating to a catalyst-inlet gas atmosphere;

a second sensor disposed on an exhaust-gas flow downstream side with respect to the present catalyst, and detecting a physical quantity relating to a catalyst-outlet gas atmosphere; and

a control device for receiving detection signals, which are output from the first sensor and the second sensor, and controlling an air-fuel ratio of the internal combustion engine.

Since the present catalyst comprises the oxidizing area, which is disposed on a downstream side with respect to the Rh area, H₂, which is generated in the Rh area, is oxidized in the oxidizing area. Accordingly, it is possible to inhibit the sudden output change-over point of the second sensor from fluctuating. Consequently, the present exhaust-gas purification controller can minimize the error in the output values from the second sensor remarkably. Therefore, not only the present exhaust-gas purification controller can have the present catalyst exhibit an improved NOₓ conversion, but also it can upgrade the accuracy of air-fuel control greatly. Moreover, the present exhaust-gas purification controller exhibits enhanced accuracy for grasping the degradation degree of catalyst.

Moreover, when the present catalyst comprises the coexistence area with Pt and Rh loaded, coexistence area which is formed on an exhaust-gas flow upstream side being more likely to become high temperatures than an exhaust-gas flow downstream side, Rh inhibits the sintering of Pt in the coexistence area so that the activity of Pt is prevented from lowering. Moreover, even if Pt is alloyed with Rh to lower the characteristics of Rh, Rh, which is loaded on the Rh area, shows the characteristics fully. In addition, when the length of the coexistence area is controlled to be 4/10 times or less as short as the overall length of the support substrate, and when the proportion of Pt with respect to Rh is controlled to fall in a range of 10≦Pt/Rh≦60 by weight ratio in the coexistence area, Rh, which is alloyed with Pt, is so less that it is possible to make use of Rh efficiently.

### BRIEF DESCRIPTION OF THE DRAWINGS

A more complete appreciation of the present invention and many of its advantages will be readily obtained as the same becomes better understood by reference to the following detailed description when considered in connection with the accompanying drawings and detailed specification, all of which forms a part of the disclosure.

FIG. 1 is a perspective diagram for illustrating a catalyst of Example No. 1 according to the present invention.

FIG. 2 is a cross-sectional diagram for illustrating the catalyst of Example No. 1 according to the present invention.

FIG. 3 is a block diagram for illustrating an exhaust-gas purification controller of Example No. 1 according to the present invention.

FIG. 4 is a flowchart for illustrating how the exhaust-gas purification controller of Example No. 1 according to the present invention carries out controlling the combustion of engine.

FIG. 5 is a time chart for illustrating the relationships between the A/F value and the output value from a second sensor when the air-fuel ratio is switched from fuel-lean atmosphere to fuel-rich atmosphere.

### BEST MODE FOR CARRYING OUT THE INVENTION

Having generally described the present invention, a further understanding can be obtained by reference to the specific preferred embodiments which are provided herein for the purpose of illustration only and not intended to limit the scope of the appended claims.

The present catalyst comprises the oxidizing area which is further formed on a downstream side with respect to the Rh area, in addition to the Rh area. Therefore, even if fuel-rich-atmosphere exhaust gases flow into the present catalyst to facilitate the steam reforming reaction in the Rh area so that H₂ is generated, the resulting H₂ is oxidized in the oxidizing area, and accordingly hardly contacts with the second sensor. As a result, not only it is possible to inhibit the sudden output change-over point of the second sensor from fluctuating, but also it is possible to improve the detection accuracy of the second sensor. Thus, the NOₓ conversion of the present catalyst upgrades as well as the air-fuel control accuracy of the present exhaust-gas purification controller enhances. In addition, the accuracy of the present exhaust-gas purification controller for grasping the degradation degree of catalyst improves as well.

The Rh area of the catalytic loading layer can preferably comprise Rh in a loading amount of from 0.05 to 5 g with respect to 1-L volume of the support substrate. When the loading amount of Rh is less than the lower limit of the range, the resulting Rh area exhibits insufficient purifying performance. When the loading amount of Rh is more than the upper limit of the range, the effect of Rh addition has saturated so that it is impossible to utilize Rh effectively. Note that the loading density of Rh in the Rh region can differ from the loading density of Rh in the coexistence area. However, from the viewpoint of production, it is convenient to control the loading density of Rh in the Rh region identical with the loading density of Rh in the coexistence area.

The forming range of the oxidizing area is not limited in particular, as far as the oxidizing area is formed on an exhaust-gas flow downstream side with respect to the Rh area. However, it is desirable to form the oxidizing area over the entire exhaust-gas flow downstream side of the catalytic loading layer with respect to the Rh area. On the oxidizing area, a catalytic ingredient, which exhibits an oxidizing activity at least, is loaded. As for such a catalytic ingredient, it is possible to exemplify Pt, Pd, Ni, and Co. Among them, it is especially preferable to use at least one member selected from the group consisting of Pt and Pd. Note that the other noble metals, or transition metals other than noble metals can be loaded on the oxidizing area in such a loading amount that does not impair the oxidizing activity of the catalytic ingredient. Note that the oxidizing area of the catalytic loading layer can preferably comprise the catalytic ingredient in a loading amount of from 0.05 to 100 g, further preferably from 1 to 40 g with respect to 1-L volume of the support substrate.

The present catalyst can desirably further comprise a coexistence area, which is disposed on an exhaust-gas flow upstream side with respect to the Rh area and on which Rh and Pt are loaded. When the present catalyst comprises the coexistence area, low-temperature exhaust gases, which are produced when starting an engine, first pass the coexistence area after they collide with the exhaust-gas inlet-end surface of the present catalyst in such a state that they have not yet turned into laminar flow. Accordingly, the heat of the exhaust gases increases the temperature of the present catalyst quickly so that Pt with good ignitability, which is loaded on the coexistence area, reaches the activation temperature in a short period of time relatively. Then, the reaction heat further increases the temperature of the present catalyst so that the temperature increment is facilitated as well on the exhaust-gas flow downstream side of the present catalyst. Consequently, the present catalyst demonstrates improved purifying performance for HC and NOₓ.

On the other hand, even when the coexistence area becomes high temperatures, since Rh inhibits the sintering of Pt, the activity of Pt is prevented from lowering so that the durability of the present catalyst enhances. Note that, even if Pt is alloyed with Rh to degrade the characteristics of Rh in the coexistence area, Rh, which is loaded on the Rh area, show the characteristics fully. Moreover, the coexistence area can preferably have a length, which is 4/10 times or less, further preferably from 0/10 to 4/10 times furthermore preferably from 2/10 to 4/10 times, as short as the overall length of the support substrate. Thus, it is possible to make the amount of Rh, which is alloyed with Pt, less. Accordingly, it is possible to use expensive Rh efficiently. When the coexistence area is formed to have a length, which is more than 4/10 times as short as the overall length of the support substrate, the proportion of Rh alloying with Pt increases so that the resulting catalyst has shown insufficient purifying performance for HC and NOₓ. The coexistence area can be formed continuously from the exhaust-gas inlet-end surface of the present catalyst. However, it has been known that catalytic ingredients, such as noble metals, which are loaded in a range of 5 mm from the exhaust-gas inlet-end surface of catalyst, contribute to catalytic reactions in lesser degrees relatively. Consequently, it is advisable to dispose the coexistence area by 5 mm or more on an exhaust-gas flow downstream side with respect to the exhaust-gas inlet-end surface of the present catalyst.

Note that, when the coexistence area is formed to have a length, which is 4/10 times or less as short as the overall length of the support substrate, the oxidizing area can desirably have a length, which is 1/5 time or less, further desirably from 1/10 to 1/5 time, as short as the overall length the support substrate: and the balance can desirably be assigned to the Rh area. When the Rh area has a length, which is more than 4/10 times as short as the overall length of the support substrate, the resulting catalyst has showed lowered purifying performance for NOₓ. Since it is sufficient for the oxidizing area to have a function of oxidizing H₂, it is satisfactory that the oxidizing area has a length, which is 1/5 time or less as short as the overall of length of the support substrate.

The coexistence area can preferably comprise Rh and Pt in a proportion of Pt with respect to Rh falling in a range of 10≦Pt/Rh≦60 by weight ratio. It is especially desirable that the proportion of Pt with respect to Rh can fall in a range of 15≦Pt/Rh≦50 by weight ratio. The proportion of Pt with respect to Rh is smaller than the lower limit of the preferable range, the resulting catalyst exhibits lowered ignitability so that it has shown degraded HC purifying performance at low temperatures. When the proportion of Pt with respect to Rh is larger than the upper limit of the preferable range, the sintering of Pt is likely to occur at high temperatures. Specifically, the coexistence area can preferably comprise Pt in a loading amount of from 0.5 to 40 g, further preferably from 5 to 40 g, furthermore preferably from 10 to 40 g, with respect to 1-L volume of the support substrate. When the loading amount of Pt is less than the lower limit of the preferable range, the resulting catalyst is poor in terms of the ignitability at low temperatures so that it has shown insufficient purifying performance for HC and NOₓ. When the loading amount of Pt is more than the upper limit of the preferable range, not only the effect of Pt addition has saturated but also the sintering of Pt is likely to occur at high temperatures. Moreover, the coexistence area can comprise Rh in such a loading amount that can inhibit loaded Pt from sintering. For example, the coexistence area can preferably comprise Rh in a loading amount of from 0.05 to 5 g, further preferably from 0.1 to 5 g, with respect to 1-L volume of the support substrate. When the loading amount of Rh is less than the lower limit of the preferable range, the sintering of Pt is likely to occur at high temperatures. Note that the other noble metals or base metals can be loaded on the coexistence area in such a loading amount that does not impair the advantages resulting from the coexistence area. However, it is desirable that only Pt and Rh can be loaded on the coexistence area.

The present catalyst can be formed as pellet shapes, honeycomb shapes, and foam shapes. The support substrate can be made of heat-resistant ceramic, such as cordierite, or metallic foil. On the inner peripheral surface of a plurality of cells, which are demarcated in the support substrate, or on the surface of the support substrate, the catalytic loading layer, which is composed of the porous oxide support and catalytic ingredient, is formed.

As for the porous oxide support, it is possible to use a single species or a plurality of species which are selected from the group consisting of Al₂O₃, SiO₂, ZrO₂, CeO₂ and TiO₂. Moreover, it is possible to use composite oxides which are composed of a plurality of the simple oxides. Among such composite oxides, it is preferable use composite oxides including CeO₂. That is, it is possible to inhibit the exhaust-gas atmospheres from fluctuating by means of the oxygen absorbing-and-releasing ability of CeO₂. Moreover, when the porous oxide support is composed of a CeO₂—ZrO₂ composite oxide, the porous oxide support made of CeO₂—ZrO₂ and with Pt loaded exhibits more upgraded oxygen absorbing-and-releasing ability than CeO₂ with Pt loaded does. In addition, the porous oxide support made of CeO₂—ZrO₂ and with Rh loaded shows more enhanced hydrogen generating ability as well as NOₓ purifying performance than CeO₂ with Rh loaded does.

The porous oxide support of the catalytic loading layer can preferably have a uniform composition over the entire length of the support substrate in view of production process. However, depending on actual cases, it is possible to use different porous oxide support for the Rh area and the oxidizing area, or further for the coexistence area. For example, the porous oxide support can be composed of Al₂O₃ in the coexistence area and oxidizing area; and can be composed of a CeO₂—ZrO₂ composite oxide in the Rh area. If such is the case, since the characteristics of catalytic ingredients furthermore enhance in all of the three areas, the present catalyst shows much better purifying performance.

The present exhaust-gas purification controller comprises the present catalyst, a first sensor, a second sensor, and a control device. The present catalyst is disposed in an exhaust channel of an internal combustion engine. The first sensor is disposed on an exhaust-gas flow upstream side with respect to the catalyst, and detects a physical quantity relating to a catalyst-inlet gas atmosphere. The second sensor is disposed on an exhaust-gas flow downstream side with respect to the catalyst, and detects a physical quantity relating to a catalyst-outlet gas atmosphere. The control device is for receiving detection signals, which are output from the first sensor and the second sensor, and controlling an air-fuel ratio of the internal combustion engine.

As for the first and second sensors, it is possible to use A/F sensors, oxygen sensors, and the like, which have been used conventionally. As for the control device, it is possible to use engine control units (hereinafter abbreviated to as “ECU”). In the second sensor at least, the sudden output change-over point might be fluctuated by H₂. The control subjects, which the control device carries out, can be the same as those of the conventional ones. By using the present catalyst, it is possible to prevent the sudden output change-over point of the second sensor from fluctuating in fuel-rich-atmosphere exhaust gases, which are produced by combusting fuel-rich air-fuel mixtures. As a result, it is possible to carry out the air-fuel ratio control with high accuracy.

### EXAMPLES

The present invention will be hereinafter described in detail with reference to examples, a comparative example and a conventional example.

### Example No. 1

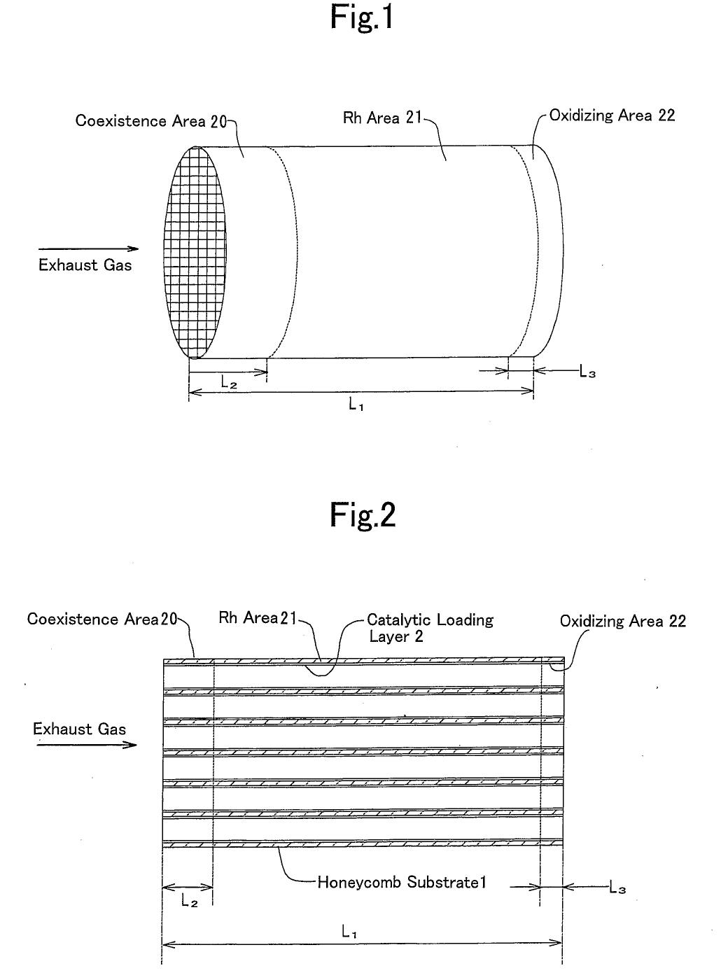

FIG. 1 and FIG. 2 illustrate a catalyst according to Example No. 1 of the present invention for purifying exhaust gases. The catalyst comprises a cylinder-shaped honeycomb substrate 1, and a catalytic loading layer 2. The honeycomb substrate 1 comprises a large number of square-shaped cells, and has an overall length of 130 mm (L₁). The catalytic loading layer 1 is formed on the surface of the cells. A coexistence area 20 is formed by a length of 20 mm (L₂) from the exhaust-gas inlet-end surface of the catalyst to an exhaust-gas flow downstream side; an Rh area 21 is formed by a length of 100 mm from the coexistence area 20 to an exhaust-gas flow downstream side; and an oxidizing area 22 is formed by a length of 10 mm (L₃) from the Rh area 21 to the exhaust-gas outlet-end surface of the catalyst.

Hereinafter, the production process of the catalyst will be described instead of describing the construction thereof in detail.

120 parts by weight of a CeO₂—ZrO₂ solid solution powder, 80 parts by weight of an activated alumina powder, and an alumina binder were mixed with a predetermined amount of water. Note that the CeO₂—ZrO₂ solid solution powder was composed of CeO₂, ZrO₂ and Y₂O₃ in a proportion of CeO₂:ZrO₂:Y₂O₃=65:30:15 by molar ratio. Moreover, the alumina binder was composed of alumina hydrate in an amount of 3 parts by weight, and 40% aluminum nitrate aqueous solution in an amount of 44 parts by weight. The resulting mixture was milled to prepare a slurry. The resultant slurry was wash coated onto the honeycomb substrate 1. Note that honeycomb substrate 1 was made of cordierite; and had a volume of 1.1 L, cells in a quantity of 600 cells/inch², an average cellular wall thickness of 75 μm, an overall length of 130 mm, and a diameter of 103 mm. Thereafter, the excessive slurry was blown off with air. After drying the honeycomb substrate 1 at 120° C., the honeycomb substrate 1 was calcined at 650° C. for 3 hours. Thus, a coating layer was formed on the entire cellular surfaces of the honeycomb substrate 1. Note that the coating layer was formed in an amount of 210 g with respect to 1-L volume of the honeycomb substrate 1.

Then, the entire coating layer was immersed into an RhCl₃ aqueous solution having a predetermined concentration (that is, the honeycomb substrate 1 was immersed into it over the entire overall length) to load Rh by means of adsorption. After drying the honeycomb substrate 1 at 120° C., the honeycomb substrate 1 was calcined at 500° C. for 1 hour. Thus, Rh was loaded on the coating layer. Note that Rh was loaded in an amount of 0.4 g with respect to 1-L volume of the honeycomb substrate 1.

Subsequently, the coating layer was impregnated with a Pt (NO₂)₂(NH₃)₂ aqueous solution having a predetermined concentration by a length of 20 mm from the exhaust-gas inlet-end surface of the honeycomb substrate 1 to an exhaust-gas flow downstream side thereof. After drying the honeycomb substrate 1 at 120° C., the honeycomb substrate 1 was calcined at 650° C. for 3 hours to load Pt on the coating layer. Thus, the coexistence area 20 was formed. Note that Pt was loaded on the coexistence area 20 in an amount of 10 g with respect to 1-L volume of the honeycomb substrate 1.

Finally, the coating layer was impregnated with a Pt (NO₂)₂(NH₃)₂ aqueous solution having a predetermined concentration by a length of 10 mm from the exhaust-gas outlet-end surface of the honeycomb substrate 1 to an exhaust-gas flow upstream side thereof. After drying the honeycomb substrate 1 at 120° C., the honeycomb substrate 1 was calcined at 650° C. for 3 hours to load Pt on the coating layer. Thus, the oxidizing area 22 was formed. Note that Pt was loaded on the oxidizing area 22 in an amount of 5 g with respect to 1-L volume of the honeycomb substrate 1.

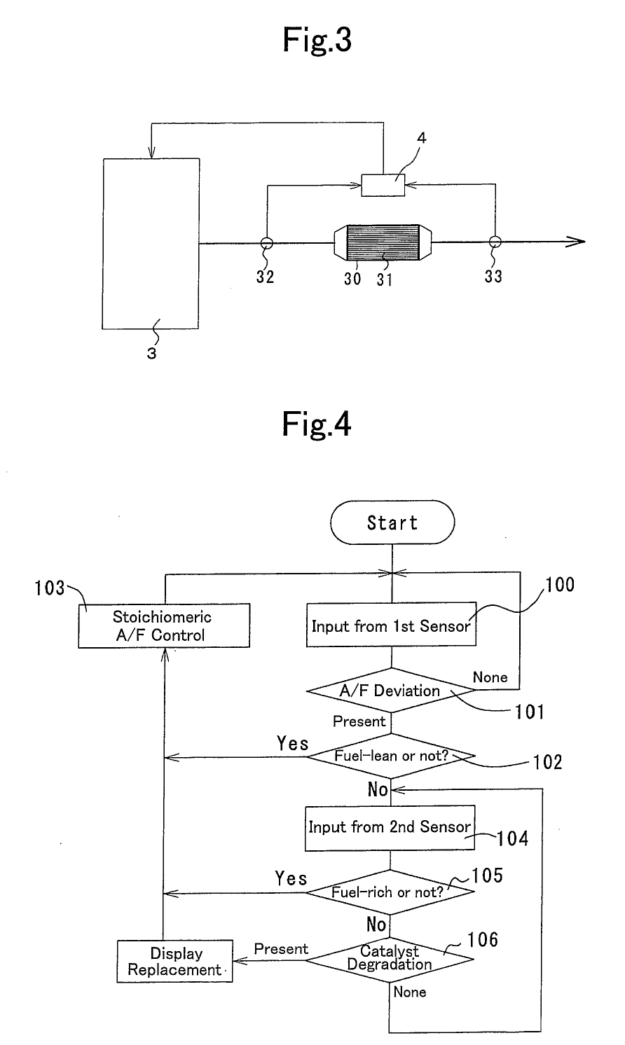

The catalyst of Example No. 1 prepared as described above was installed to an exhaust system of an automobile immediately below the 2.4-L displacement engine to make an exhaust-gas purification controller illustrated in FIG. 3.

The exhaust-gas purification controller comprises an engine 3, a catalytic converter 30, a catalyst 31, a first sensor 32, a second sensor 33, and a control device 4. The catalytic converter 30 is placed in the exhaust pipe of the engine 3. The catalyst 31 is installed within the catalytic converter 30. The first sensor 32 comprises an A/F sensor, which is placed between the engine 3 and the catalytic converter 30 and detects the A/F equivalent value of inlet exhaust gases to the catalyst 31. The second sensor 33 comprises an oxygen sensor, which is placed on an exhaust-gas flow downstream side with respect to the catalytic converter 30 and detects an oxygen gas concentration in outlet exhaust gases from the catalyst 31. The controller device 4, to which detection signals are input from the first sensor 32 and second sensor 33, controls the air-fuel ratio of the engine 3 based on the input values.

FIG. 4 illustrates how the control device 4 carries out the control subjects. When the engine 3 is started, the first sensor 32 first detects the catalyst-inlet gas atmosphere at step 100. At step 101, the control device 4 judges the deviation of the detected catalyst-inlet gas atmosphere from the stoichiometric A/F ratio. When the control device 4 judges that the A/F ratio falls in a range of 14.6±0.05, the stoichiometric atmosphere, the control device 4 does not do anything and returns the programmed control process to step 100. On the other hand, when the control device 4 judges that the A/F ratio deviates from 14.6, the theoretical stoichiometric value, by more than ±0.05, the control device 4 judges whether the catalyst-inlet gas atmosphere derives from fuel-lean atmosphere or not at step 102. When the control device 4 judges that the catalyst-inlet gas atmosphere derives from fuel-lean atmosphere, the control device 4 controls the fuel injection volume so as to make the A/F ratio fall in a range of 14.6±0.05 at step 103. Then, the control device 4 returns the programmed control process to step 100. On the contrary, when the catalyst-inlet gas atmosphere does not derive from fuel-lean atmosphere, the control device 4 judges that the catalyst-inlet gas atmosphere derives from fuel-rich atmosphere. Then, the control device 4 has the second sensor 33 detect the oxygen concentration of the catalyst-outlet gas atmosphere at step 104.

At step 105, the control device 4 judges whether the catalyst-outlet gas atmosphere derives from fuel-rich atmosphere or not. When the catalyst-outlet gas atmosphere derives from fuel-rich atmosphere, the control device 4 controls the fuel injection volume so as to make the A/F ratio fall in a range of 14.6±0.05 at step 103. Thereafter, the control device 4 returns the programmed control process to step 100. On the contrary, when the control device 4 does not judge that the catalyst-outlet gas atmosphere derives from fuel-rich atmosphere, the control device 4 refers to records, such as the accumulated service time and thermal history of the catalyst 31, to judge whether the catalyst 31 has been degraded or not based on a map, which is stored separately, at step 106.

When the control device 4 does not judge that the catalyst 31 has been degraded, the control device 4 returns the programmed control process to step 104 to have the second sensor 33 re-detect the oxygen concentration of the catalyst-outlet gas atmosphere. On the other hand, when the control device 4 judges that the catalyst 31 has been degraded, the control device 4 displays a replacement symbol to call the driver's attention to the replacement of the catalyst 31. Moreover, at step 103, the control device 4 controls the fuel injection volume so as to make the A/F ratio fall in a range of 14.6±0.05. Thereafter, the control device 4 returns the programmed control process to step 100.

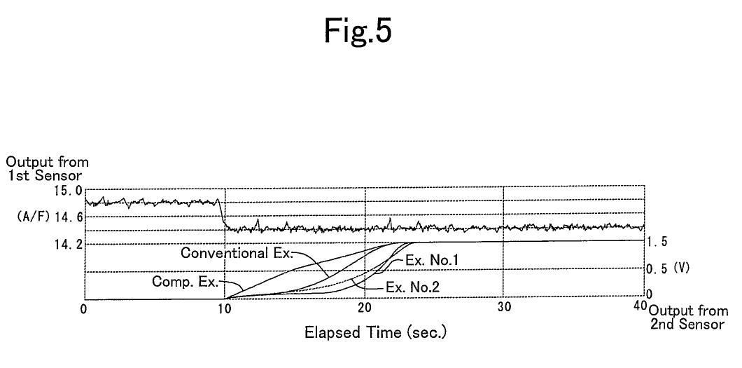

Using the above-described exhaust-gas purification controller of Example No. 1, the catalyst of Example No. 1 was first subjected to a degradation treatment at an inlet gas temperature of 950° C. (or a catalyst bed temperature of 1,000° C.) for 100 hours. After completing the degradation treatment, the engine 3 was operated under the following conditions: a revolving speed of 1,600 rpm; and an exhaust-gas flow rate of 10 g/second. Meanwhile, the output values of the second sensor 33 were measured with time after the target value of the engine 3's A/F ratio, which the control device 4 judged according to the detected value of the first sensor 32, was switched from 14.8 to 14.4. In this instance, note that the air-fuel ratio control was carried out so as to keep the target value of the engine 3's A/F ratio constant at 14.8 or 14.4 as illustrated in FIG. 5, without performing the programmed control shown in FIG. 4. FIG. 5 illustrates the result of measuring the output values of the second sensor 33 with time.

Moreover, the engine 3 was operated under a steady driving condition, 60 km/hour, while performing the programmed control shown in FIG. 4. Meanwhile, the NOₓ emission was measured with time. Table 1 below summarizes the result of measuring the NOₓ emission.

### Example No. 2

Except that the catalytic ingredient loaded on the oxidizing area 22 was changed from Pt to Pd, a catalyst of Example No. 2 was prepared in the same manner as set forth in Example No. 1. Moreover, the output values of the second sensor 33 and the NOₓ emission under a steady driving condition were measured in the same manner as described in Example No. 1. FIG. 5 illustrates the result of measuring the second sensor 33's output values, and Table 1 below summarizes the result of measuring the NOₓ emission.

### Comparative Example

Except that no oxidizing area 22 was formed, that is, the Rh area 21 was formed by a length of 110 mm from the coexistence area 20 to the exhaust-gas outlet-end surface of the honeycomb substrate 1, a catalyst of Comparative Example was prepared in the same manner as set forth in Example No. 1. Moreover, the output values of the second sensor 33 and the NOₓ emission under a steady driving condition were measured in the same manner as described in Example No. 1. FIG. 5 illustrates the result of measuring the second sensor 33's output values, and Table 1 below summarizes the result of measuring the NOₓ emission.

### Conventional Example

A honeycomb substrate 1 was prepared. Note that a coating layer was formed on the honeycomb substrate 1 in the same manner as Example No. 1. Then, the entire coating layer was immersed into an RhCl₃ aqueous solution having a predetermined concentration (that is, the honeycomb substrate 1 was immersed into it over the entire overall length) to load Rh by means of adsorption. After drying the honeycomb substrate 1 at 120° C., the honeycomb substrate 1 was calcined at 500° C. for 1 hour. Thus, Rh was loaded on the coating layer. Note that Rh was loaded in an amount of 0.4 g with respect to 1-L volume of the honeycomb substrate 1. Subsequently, the coating layer was impregnated with a Pt (NO₂)₂ (NH₃)₂ aqueous solution having a predetermined concentration by the overall length of the honeycomb substrate 1. After drying the honeycomb substrate 1 at 120° C., the honeycomb substrate 1 was calcined at 650° C. for 3 hours to load Pt on the coating layer. Note that Pt was loaded on the coating layer in an amount of 1.5 g with respect to 1-L volume of the honeycomb substrate 1.

Except that the resulting catalyst of Conventional Example was used, the output values of the second sensor 33 and the NOₓ emission under a steady driving condition were measured in the same manner as described in Example No. 1. FIG. 5 illustrates the result of measuring the second sensor 33's output values, and Table 1 below summarizes the result of measuring the NOₓ, emission.

### Evaluation

TABLE 1

| | NOₓ Emission (g/km) |
|---|---|
| Ex. #1 | 0.0375 |
| Ex. #2 | 0.0405 |
| Comparative Ex. | 0.0525 |
| Conventional Ex. | 0.0591 |

From FIG. 5, it is understood that the second sensor 33 exhibited the sudden output change-over point, which shifted greatly more on a shorter elapsed-time side, in the Comparative Example than in the Example Nos. 1 and 2 as well as Conventional Example. Specifically, the Comparative Example carried out the judgement whether the catalyst-outlet exhaust gas was fuel-rich or not in a shorter period of time than the Conventional Example did. Accordingly, in the exhaust-gas purification control illustrated in FIG. 4, the control device 4 carried out the stoichiometric A/F control at an earlier time to make the air-fuel ratio the theoretical stoichiometric value. Consequently, in the Comparative Example, the air-fuel mixture was kept in fuel-rich atmosphere in a shorter period of time than it was in the Conventional Example. Therefore, the Comparative Example is disadvantageous for purifying NOₓ.

However, in Example Nos. 1 and 2, the second sensor 33 exhibited the sudden output change-over point, which shifted by lesser shift magnitude than that the second sensor 33 did in the Conventional Example. Additionally, the sudden output change-over point shifted more on a longer elapsed-time side. Therefore, in Example Nos. 1 and 2, it was possible to secure an ample time until the control device 4 judged that catalyst-outlet exhaust-gas atmosphere derived from a fuel-rich air-fuel mixture. As a result, Example Nos. 1 and 2 could upgrade the NOₓ purifying performance. Moreover, from Table 1 above, it is appreciated that the Comparative Example exhibited the poorer NOₓ emission than Example Nos. 1 and 2 did. It is apparent that the disadvantage resulted from the fact that the sudden output change-over point of the second sensor 33 shifted more on a shorter elapsed-time side in the Comparative Example.

Note that, in the Conventional Example, the sudden output change-over point of the second sensor 33 shifted more on a shorter elapsed-time side than in Example Nos. 1 and 2 as shown in FIG. 5; but the NOₓ emission degraded more than that of the Comparative Example as set forth in Table 1. It is believed that the following action brought about the phenomena: Rh was alloyed with Pt in the degradation treatment so that the reduction activity of Rh had been degraded.

### INDUSTRIAL APPLICABILITY

The present catalyst, and the present exhaust-gas purification controller using the same can be applied to the purification of exhaust gases emitted form internal combustion engines, in particular to the purification of HC in low-temperature regions, such as at the time of starting engine, and the purification of NOₓ.

1. A catalyst for purifying exhaust gases, the catalyst comprising:
a support substrate having an exhaust-gas flow passage; and
a catalytic loading layer formed on a surface of the exhaust-gas flow passage, and composed of a porous oxide support and a catalytic ingredient, the catalytic loading layer comprising:
an Rh area on which rhodium is loaded as the catalytic ingredient; and
an oxidizing area which is formed on an exhaust-gas flow downstream side with respect to the Rh area, and on which a catalytic ingredient exhibiting an oxidizing activity at least is loaded.

2. The catalyst set forth in claim 1, wherein the catalytic loading layer further comprises a coexistence area, which is formed on an exhaust-gas flow upstream side with respect to the Rh area, and on which rhodium and platinum are loaded as the catalytic ingredient.

3. The catalyst set forth in claim 2, wherein:
the support substrate has a predetermined overall length;
the coexistence area of the catalytic loading layer has a length which is 4/10 times or less as short as the predetermined overall length of the support substrate; and
the coexistence area comprises rhodium and platinum in a proportion of Pt with respect to Rh falling in a range of 10≦Pt/Rh≦60 by weight ratio.

4. The catalyst set forth in claim 3, wherein the oxidizing area of the catalytic loading layer has a length which is 1/5 time or less as short as the predetermined overall length of the support substrate.

5. The catalyst set forth in claim 1, wherein the Rh area of the catalytic loading layer comprises Rh in a loading amount of from 0.05 to 5 g with respect to 1-L volume of the support substrate.

6. The catalyst set forth in claim 1, wherein the oxidizing area of the catalytic loading layer comprises the catalytic ingredient in a loading amount of from 0.05 to 100 g with respect to 1-L volume of the support substrate.

7. The catalyst set forth in claim 2, wherein the coexistence area of the catalytic loading layer comprises Rh in a loading amount of from 0.05 to 5 g with respect to 1-L volume of the support substrate.

8. The catalyst set forth in claim 2, wherein the coexistence area of the catalytic loading layer comprises Pt in a loading amount of from 0.5 to 40 g with respect to 1-L volume of the support substrate.

9. The catalyst set forth in claim 1, wherein the porous oxide support includes ceria at least.

10. An exhaust-gas purification controller, comprising:
the catalyst set forth in claim 1, and disposed in an exhaust channel of an internal combustion engine;
a first sensor disposed on an exhaust-gas flow upstream side with respect to the catalyst, and detecting a physical quantity relating to a catalyst-inlet gas atmosphere;
a second sensor disposed on an exhaust-gas flow downstream side with respect to the catalyst, and detecting a physical quantity relating to a catalyst-outlet gas atmosphere; and
a control device for receiving detection signals, which are output from the first sensor and the second sensor, and controlling an air-fuel ratio of the internal combustion engine.
